(19) United States
(12) Patent Application Publication
(10) Pub. No.: US 2026/0302505 A1
(43) Pub. Date: Oct. 1, 2026

(54) PRESSURE RELIEF NOTCH ON A POUCH OF A BATTERY

(71) Applicant: Apple Inc., Cupertino, CA (US)

(72) Inventors: Saeed Uzzaman, Mountain House, CA (US); Steven M. Labovitz, Sunnyvale, CA (US); Rajesh Kandibanda, Menlo Park, CA (US); Joshua M. Chien, Menlo Park, CA (US)

(21) Appl. No.: 19/094,346

(22) Filed: Mar. 28, 2025

(51) Int. Cl. H01M 50/342; H01M 10/04; H01M 50/105; H01M 50/119; H01M 50/121; H01M 50/128

(52) U.S. Cl. CPC H01M 50/3425; H01M 10/0436; H01M 50/105; H01M 50/119; H01M 50/121; H01M 50/128

(57) ABSTRACT

The present disclosure is directed to a battery including a plurality of electrodes and a pouch defining a pouch interior configured to enclose the plurality of electrodes. The pouch includes a plurality of layers including a nylon layer, a polypropylene layer, and an aluminum layer between the nylon layer and the polypropylene layer, where the polypropylene layer is closer to the pouch interior than the nylon layer and the aluminum layer. The pouch also includes a notch formed in at least one layer of the plurality of layers, wherein the notch is configured to facilitate a break in the pouch through the plurality of layers at or adjacent to the notch based on a pressure being applied in the pouch interior exceeding a threshold pressure.

### BACKGROUND

The present disclosure relates generally to a battery (e.g., a battery cell). More specifically, the present disclosure relates to creating a notch on a pouch of the battery, where the notch is configured to cause a break in the pouch when an internal pressure (e.g., an internal gas pressure) within the pouch exceeds a threshold pressure.

Certain batteries, such as certain types of secondary or rechargeable batteries (e.g., lithium-ion batteries, nickel-metal hydride batteries, lithium iron phosphate or LFP batteries, nickel manganese cobalt or NMC batteries, etc.), include componentry (e.g., electrodes, electrolyte, etc.) disposed in a flexible pouch. Such batteries may be commonly referred to as pouch batteries or pouch cells. Internal pressure (e.g., internal gas pressure) within the flexible pouch may fluctuate during operation, including testing (e.g., thermal testing, pressure testing, etc.), of the battery as various electrochemical reactions take place, thereby causing the flexible pouch to swell and retract in response to the varying internal pressure.

Regulations may require that the flexible pouch include one or more mechanisms for releasing internal gas pressure in response to an over-pressurization condition (e.g., when the internal pressure within the flexible pouch exceeds a threshold pressure), as the over-pressurization condition can lead to various negative effects. Unfortunately, traditional mechanisms for releasing internal pressure from the flexible pouch in response to the over-pressurization condition are expensive, unreliable, undesirably large, and/or unresponsive to modern battery technologies. Accordingly, it is now recognized that improved batteries capable of accurately and reliably releasing internal pressure in response to over-pressurization conditions are desired .

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment , a battery includes a plurality of electrodes and a pouch defining a pouch interior configured to enclose the plurality of electrodes. The pouch includes a plurality of layers including a nylon layer, a polypropylene layer, and an aluminum layer between the nylon layer and the polypropylene layer, where the polypropylene layer is closer to the pouch interior than the nylon layer and the aluminum layer. The pouch also includes a notch formed in at least one layer of the plurality of layers, wherein the notch is configured to facilitate a break in the pouch through the plurality of layers at or adjacent to the notch based on a pressure being applied in the pouch interior exceeding a threshold pressure.

In another embodiment , a method includes forming a notch in an aluminum layer, adhering a nylon layer to a first surface of the aluminum layer, adhering a polypropylene layer to a second surface of the aluminum layer opposing the first surface of the aluminum layer, forming a battery pouch using the aluminum layer, the nylon layer, and the polypropylene layer, and forming a battery by disposing one or more electrodes into the battery pouch.

In yet another embodiment , a battery includes a plurality of electrodes and a pouch defining a pouch interior configured to enclose the plurality of electrodes. The pouch includes an aluminum layer, at least one notch formed in a surface of the aluminum layer, and a nylon layer adhered to the surface of the aluminum layer such that the nylon layer extends into or over a channel at least partially defined by the at least one notch.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a schematic perspective view of a battery (e.g., a battery cell) employed to power the electronic device of FIG. 1, where the battery includes a battery pouch and a notch disposed in at least one layer of a plurality of layers of the battery pouch, according to embodiments of the present disclosure;

FIG. 3 is a schematic cross-sectional view of a portion of a battery pouch, such as the battery pouch of the battery illustrated in FIG. 2, where the battery pouch includes a plurality of layers, according to embodiments of the present disclosure;

FIG. 4 is a schematic diagram illustrating a process for forming a battery pouch, such as the battery pouch of the battery illustrated in FIG. 2, having a plurality of layers, including laser etching a notch in a surface of a layer of the plurality of layers and adhering an additional layer of the plurality of layers on the surface such that the additional layer extends over or across a channel at least partially defined by the notch, according to embodiments of the present disclosure;

FIG. 5 is a schematic diagram illustrating a process for forming a battery pouch, such as the battery pouch of the battery illustrated in FIG. 2, having a plurality of layers, including laser etching a notch in a surface of a layer of the plurality of layers and adhering an additional layer of the plurality of layers onto the surface such that the additional layer extends into a channel at least partially defined by the notch, according to embodiments of the present disclosure;

FIG. 6 is a schematic diagram illustrating a process for forming a battery pouch, such as the battery pouch of the battery illustrated in FIG. 2, having a plurality of layers, including laser etching a notch into at least two layers of the plurality of layers, according to embodiments of the present disclosure;

FIG. 7 is a schematic diagram illustrating a process for forming a notch in at least one layer of a plurality of layers of a battery pouch, such as the battery pouch of the battery illustrated in FIG. 2, via a bladed roller, according to embodiments of the present disclosure;

FIG. 8 is a schematic diagram of a blade and a roller separate from the blade, where the blade and the roller are configured to coordinate to form a notch in at least one layer of a plurality of layers of a battery pouch, such as the battery pouch of the battery illustrated in FIG. 2, according to embodiments of the present disclosure;

FIG. 9 is a schematic diagram of a blade assembly (e.g., a first blade and a second blade) and a roller separate from the blade assembly, where the blade assembly and the roller are configured to coordinate to dispose a plurality of notches (e.g., a first notch and a second notch) in at least one layer of a plurality of layers of a battery pouch, such as the battery pouch of the battery illustrated in FIG. 2, according to embodiments of the present disclosure;

FIG. 10 is a schematic perspective view of a mask employed in a chemical etching process to dispose a notch in at least one layer of a plurality of layers of a battery pouch, such as the battery pouch of the battery illustrated in FIG. 2, according to embodiments of the present disclosure;

FIG. 11 is a schematic cross-sectional view of a battery pouch, such as the battery pouch of the battery illustrated in FIG. 2, having a notch formed in a layer of a plurality of layers of the battery pouch, according to embodiments of the present disclosure;

FIG. 12A is a schematic front view of a battery employed in the electronic device of FIG. 1, where the battery includes a battery pouch and the battery pouch includes a linear notch along a body of the battery pouch, according to embodiments of the present disclosure;

FIG. 12B is a schematic front view of a battery employed in the electronic device of FIG. 1, where the battery includes a battery pouch and the battery pouch includes two linear notches along a body of the battery pouch, according to embodiments of the present disclosure;

FIG. 12C is a schematic front view of a battery employed in the electronic device of FIG. 1, where the battery includes a battery pouch and the battery pouch includes three linear notches along a body of the battery pouch, according to embodiments of the present disclosure;

FIG. 12D is a schematic front view of a battery employed in the electronic device of FIG. 1, where the battery includes a battery pouch and the battery pouch includes three linear notches along a body of the battery pouch, according to embodiments of the present disclosure;

FIG. 12E is a schematic front view of a battery employed in the electronic device of FIG. 1, where the battery includes a battery pouch and the battery pouch includes four circular notches along a body of the battery pouch, according to embodiments of the present disclosure;

FIG. 12F is a schematic front view of a battery employed in the electronic device of FIG. 1, where the battery includes a battery pouch and the battery pouch includes two curvilinear notches along a body of the battery pouch, according to embodiments of the present disclosure;

FIG. 12G is a schematic front view of a battery employed in the electronic device of FIG. 1, where the battery includes a battery pouch and the battery pouch includes multiple circular notches and multiple curvilinear notches separate from the multiple circular notches along a body of the battery pouch, according to embodiments of the present disclosure; and

FIG. 13 is a process flow diagram illustrating a method of manufacturing a battery with a battery pouch having a plurality of layers and a notch disposed in at least one layer of the plurality of layers, according to embodiments of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment ” or “an embodiment ” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on).

The present disclosure is directed to a battery (e.g., a battery cell) with improved venting capability over traditional configurations. In particular, presently disclosed embodiments include a battery with a pouch (e.g., a battery pouch) that includes a plurality of layers and at least one notch formed in at least one layer of the plurality of layers.

Certain batteries, such as certain types of secondary or rechargeable batteries (e.g., lithium-ion batteries, nickel-metal hydride batteries, lithium iron phosphate or LFP batteries, nickel manganese cobalt or NMC batteries, etc.), include componentry disposed in a flexible pouch, referred to herein as a battery pouch. For example, electrodes, one or more separators, and electrolyte, among other possible componentry, may be disposed in a pouch interior of the battery pouch. Terminals electrically coupled with the electrodes may protrude through openings in the battery pouch to an external space to facilitate electrically coupling the battery with a load, where the openings are sealed about the terminals.

During operation of the batteries described above, including during thermal and/or pressure testing, an internal pressure (e.g., an internal gas pressure) within the pouch interior of battery pouch may vary (e.g., in response to various electrochemical reactions), causing the battery pouch to expand and contract with the varying internal pressure. For a variety of reasons, including but not limited to compliance with battery regulations, it may be desirable to ensure that the internal pressure within the pouch interior does not exceed a threshold pressure. For these and other possible reasons, presently disclosed embodiments include a venting mechanism configured to release at least some of the internal pressure in response to the internal pressure exceeding the threshold pressure. For example, presently disclosed batteries include at least one notch formed in at least one layer of a plurality of layers of the battery pouch, where the notch facilitates a break in the pouch adjacent to the notch and through the plurality of layers based on the internal pressure exceeding the threshold pressure. That is, the notch may facilitate the release of gases (e.g., electrolyte in gaseous form) from the pouch interior through an opening formed by the above-described break to reduce the internal pressure and/or reduce or eliminate the chances of a thermal event occurring.

In some embodiments, multiple notches may be disposed in at least one layer of the plurality of layers, where the multiple notches coordinate to facilitate the break through the battery pouch in response to the internal pressure exceeding the threshold pressure. As described in greater detail with reference to later drawings, various characteristics of the notch or notches, such as a depth or thickness, a length, and/or a shape thereof, may be dependent on (e.g., selected or fine-tuned based on) various characteristics of the battery, such as the desired threshold pressure, material constituents of the battery (e.g., of the electrodes, of the plurality of layers, etc.), a size of the battery, an energy density of the battery, a power capability and/or rating of the battery, and the like.

In general, embodiments of the present disclosure may improve venting reliability, accuracy, and/or fine-tuning relative to traditional configurations. Additionally or alternatively, the notch (or notches) and associated processes may be more cost-effective (e.g., less expensive) than traditional configurations and/or consume less space than traditional configurations, thereby reducing a cost of the battery and/or improving a volumetric energy density of the battery, respectively, relative to traditional configurations. These and other aspects of the present disclosure are described in greater detail below with reference to the drawings.

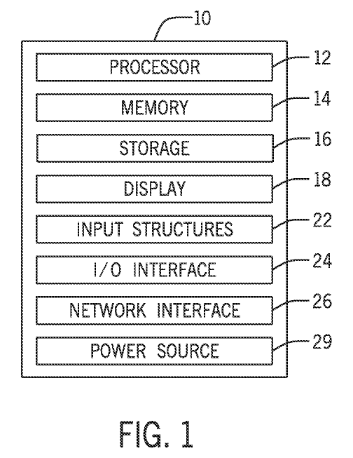

FIG. 1 is a block diagram of an electronic device 10, according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive data between one another. It should be noted that FIG. 1 is merely one example of a particular implementation and is intended to illustrate the types of components that may be present in the electronic device 10 .

By way of example, the electronic device 10 may include any suitable computing device, including a desktop or notebook computer, a portable electronic or handheld electronic device such as a wireless electronic device or smartphone, a tablet, a wearable electronic device, and other similar devices. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector provided by Apple Inc. of Cupertino, California, a universal serial bus (USB), or other similar connector and protocol. The network interface 26 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3rd generation (3G) cellular network, universal mobile telecommunication system (UMTS), 4th generation (4G) cellular network, long term evolution (LTE®) cellular network, long term evolution license assisted access (LTE-LAA) cellular network, 5th generation (5G) cellular network, and/or New Radio (NR) cellular network, a 6th generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth). The power source 29 of the electronic device 10 may include any suitable source of power, such as a secondary or rechargeable battery (e.g., a lithium-ion battery, a nickel-metal hydride battery, a lithium iron phosphate or LFP battery, a nickel manganese cobalt or NMC battery, etc.) and/or an alternating current (AC) power converter.

In accordance with the present disclosure, and as described in detail below with reference to later drawings, a battery (e.g., corresponding to the power source 29) of the electronic device 10, such as a battery cell, includes a battery pouch defining a pouch interior configured to receive various componentry of the battery (e.g., a plurality of electrodes of the battery, at least one separator, electrolyte, etc.), where the battery pouch includes a plurality of layers and at least one notch formed in at least one layer of the plurality of layers. The notch is configured to facilitate a break in the pouch through the plurality of layers at or adjacent to the notch based on an internal pressure (e.g., internal gas pressure) being applied in the pouch interior exceeding a threshold pressure. Various characteristics of the notch or notches (e.g., length, depth or thickness, shape, etc.) may be fine-tuned based on the desired threshold pressure and/or various characteristics of the battery (e.g., a size of the battery, a shape of the battery, material constituents of the electrodes, material constituents of the plurality of layers, etc.). These and other aspects of the present disclosure are described in detail below.

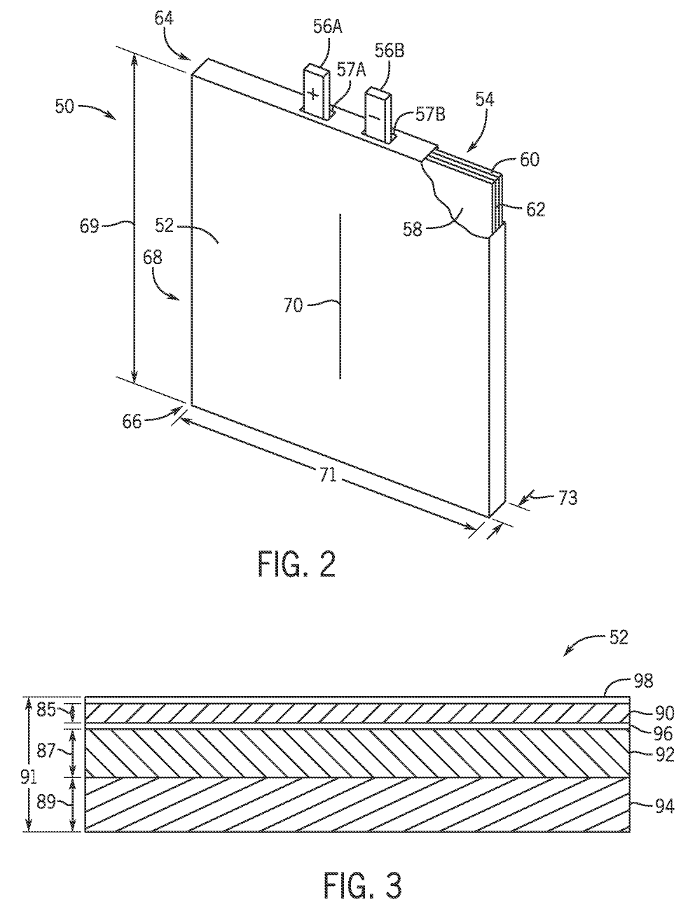

FIG. 2 is a perspective view of an embodiment of a battery 50 (e.g., a battery cell) employed, for example, in the electronic device 10 discussed above with respect to FIG. 1 (e.g., where the battery 50 corresponds to the power source 29). The battery 50 may be referred to as a pouch battery (e.g., a pouch cell) in certain instances of the present disclosure. For example, the battery 50 may include a flexible battery pouch 52 (e.g., a battery housing, a battery enclosure), referred to for brevity below as the battery pouch 52, defining a pouch interior 54. As shown, the battery 50 also may include a first terminal 56A and a second terminal 56B. Collectively, the first terminal 56A and the second terminal 56B may be referred to as terminals 56 of the battery 50. As shown, the first terminal 56A and the second terminal 56B may protrude from corresponding openings 57A, 57B in the battery pouch 52, where the openings 57A, 57B may be sealed about the first terminal 56A and the second terminal 56B, respectively. The battery pouch 52 may include a relatively soft and/or flexible pouch that receives an electrolyte and one or more electrode assemblies (e.g., the at least one cathode 58, the at least one anode 60, and at least one separator 62), among other possible componentry, where the battery pouch 52 may be pinched or otherwise sealed along a perimeter thereof to enclose the above-described componentry therein.

In some embodiments, multiple instances of the cathode 58, the anode 60, and/or the separator 62 may be disposed within the pouch interior 54. Although the battery pouch 52 in FIG. 2 includes a generally rectangular prism shape, it should be appreciated that in alternative or additional embodiments, the battery pouch 52 may have any other viable form (e.g., in shape and/or size). The cathode 58, the anode 60, and the separator 62 may be stacked or, in other embodiments, wound into a jelly roll. The cathode 58 may include phosphate and/or a metal oxide in certain embodiments, and the anode 60 may include graphite and/or silicon in certain embodiments, although material constituents (e.g., active material constituents) of the cathode 58 and the anode 60 may vary in certain other embodiments. For example, the battery 50 may include a lithium-ion battery with associated active materials of the cathode 58 and the anode 60 , a nickel-metal hydride battery with associated active materials of the cathode 58 and the anode 60 , a lithium iron phosphate (LFP) battery with associated active materials of the cathode 58 and the anode 60 , a nickel manganese cobalt (NMC) battery with associated active materials of the cathode 58 and the anode 60 , or some other type of rechargeable (e.g., secondary) battery.

The cathode 58 may be disposed on a first side of the separator 62 and the anode 60 may be disposed on a second side of the separator 62 in the illustrated embodiment. The anode 60 may include anode active material, as previously described. In some embodiments, the anode active material may be coated or otherwise disposed on a portion of an anode current collector such that an anode tab of the anode current collector may be exposed (e.g., uncoated or uncovered by the anode active material). Additionally, or alternatively, the anode tab(s) of the anode(s) 60 may be electrically coupled with one of the terminals 56, such as the second terminal 56B, where the second terminal 56B acts as an electrical conductor between the anode(s) 60 and external circuitry. For example, the second terminal 56B may receive and/or output at least a portion of the electrical power or current between the anode(s) 60 and the external circuitry. The external circuitry may include the processor 12, the memory 14, the storage 16, the display 18, the input structures 22, the I/ O interface 24, or the network interface 26 discussed above with respect to FIG. 1, or any combination thereof, among other possible componentry.

The cathode 58 may include cathode active material, as previously described. In some embodiments, the cathode active material is coated or otherwise disposed on a portion of a cathode current collector such that a cathode tab of the cathode current collector is exposed (e.g., uncoated by the cathode active material). Additionally, or alternatively, the cathode tab(s) of the cathode(s) 58 may be electrically coupled with one of the terminals 56, such as the first terminal 56A, where the first terminal 56A acts as an electrical conductor between the cathode(s) 58 and the external circuitry. For example, the first terminal 56A may receive and/or output at least a portion of the electrical power or current between the cathode(s) 58 and the external circuitry. As mentioned above, the external circuitry may include the processor 12, the memory 14, the storage 16, the display 18, the input structures 22, the I/ O interface 24, or the network interface 26 discussed above with respect to FIG. 1, or any combination thereof, among other possible componentry.

The battery pouch 52 may include a first side 64 from which at least one of the terminals 56 extends, a second side 66 opposing the first side 64, and a body 68 extending from the first side 64 to the second side 66. The battery pouch 52 may include a height 69 (e.g., in a vertical direction, or y-direction) extending from the first side 64 to the second side 66 and a width 71 (e.g., in a horizontal direction, or x-direction) extending transverse to the height 69. In an embodiment, the battery pouch 52 may include a notch 70 positioned along the body 68 of the battery pouch 52 and extending along the height 69 (e.g., parallel to the height 69). In another embodiment, the notch 70 of the battery pouch 52 may be positioned along the body 68 of the battery pouch 52 and extending along the width 71 . Other shapes and orientations of the notch 70 are also possible. While only one notch 70 is shown in FIG. 2, it should be appreciated that multiple notches having the same or varying orientations, locations, and/or shapes may be employed in certain embodiments of the present disclosure. In general, the notch 70 may include a depth extending in a direction parallel to a thickness 73 (or depth) of the battery 50 or battery pouch 52 thereof. In general, the notch 70 is configured to enable a venting of gases (e.g., electrolyte in gaseous form) from the pouch interior 54 of the battery pouch 52 in response to an internal pressure (e.g., internal gas pressure) within the pouch interior 54 exceeding a threshold pressure. That is, the notch 70 may be configured to facilitate a breakthrough the battery pouch 52 in response to or based on the internal pressure exceeding the threshold pressure, as described in greater detail below with reference to later drawings.

The battery pouch 52 may include a plurality of layers, where the notch 70 may be formed in at least one layer of the plurality of layers. To form the notch 70, a portion of the at least one layer may be removed and/or weakened at a particular location of the layer. The notch 70 may be formed by mechanical etching, chemical etching, laser etching, blade cutting, and the like. The notch 70 may be any suitable shape, location, depth, and/or size, although characteristics of the notch 70 (e.g., shape, location, depth, and/or size), described in greater detail with reference to later drawings, may contribute to certain technical benefits related to venting (e.g., improved venting reliability, accuracy, and/or fine-tuning) over traditional configurations. For example, characteristics of the notch 70 may be fine-tuned to cause venting at a desired or target threshold pressure, which may be based on battery regulations and/or characteristics of the battery 50, such as material constituents, a size, a shape, or a type thereof. In some embodiments, the notch 70 may include or at least partially define a channel with a depth extending along the thickness 73 of the battery 50 or the battery pouch 52 thereof, as previously described, where the depth extends into at least one layer of the plurality of layers.

As described above, characteristics of the notch 70 may be selected based on desired venting characteristics and/or various characteristics of the battery 50. For example, characteristics of the notch 70 may be selected such that the notch 70 causes a breakthrough the battery pouch 52 in response to the pressure within the pouch interior 54 exceeding a selected threshold pressure. In addition to a quantity of the notches 70, selectable (e.g., tunable) characteristics of each notch 70 may include a size of the notch 70 (e.g., a length, a width, and/or a depth of the notch 70), a shape of the notch 70, and the like.

In some embodiments, characteristics of the notch 70 may be at least partially dependent on (e.g., selected or fine-tuned based at least in part on) the desired threshold pressure and/or internal chemistry or material constituents of the battery 50 (e.g., one or more materials of the cathode 58 , one or more materials of the anode 60 , a type or materials of the electrolyte, etc.), material constituents of the various layers of the battery pouch 52 , a size of the battery 50 or individual componentry thereof (e.g., thicknesses of the layers of the battery pouch 52), a load-specific application of the battery 50, and/or other considerations or characteristics. For example, a relatively deep notch 70 may be included if a relatively low threshold pressure is desired, whereas a relatively shallow notch 70 may be included if a relatively high threshold pressure is desired. In another example, a relatively short notch 70 may be included if a relatively high threshold pressure is desired, whereas a relatively long notch 70 may be included if a relatively low threshold pressure is desired. In still another example, the notch 70 may be formed in one or more particular layers of the battery pouch 52 and/or one or more particular locations of the battery pouch 52 based on the desired threshold pressure, characteristics of the battery 50, or both. In certain embodiments, as previously described, the battery pouch 52 may include two or more notches 70 with respective shapes and/or sizes, where the two or more notches 70 and characteristics thereof, along with other possible characteristics of the battery 50 (e.g., size, shape, material constituents, etc.), collectively dictate the threshold pressure at which venting occurs.

During thermal testing or other operations of the battery 50, for example, the notch 70 may open (e.g., break) to release gases (e.g., electrolyte in gaseous form) from the pouch interior 54 based on the pressure being applied in the pouch interior 54 exceeding the threshold pressure. For example, the notch 70 may be configured to facilitate a break in the battery pouch 52 through the plurality of layers, including the layer(s) in which the notch 70 is formed and the layer(s) in which the notch 70 is not formed. The break may facilitate the movement of gases (e.g., electrolyte in gaseous form) from the pouch interior 54 to a surrounding environment, thereby releasing pressure buildup in the pouch interior 54 and reducing and/or eliminating the chances of a thermal event occurring. These and other aspects of the notch are described in greater detail below with reference to later drawings.

FIG. 3 is a cross-sectional view of an embodiment of a battery pouch, such as the battery pouch 52 of the battery 50 illustrated in FIG. 2, where the battery pouch 52 includes a plurality of layers. The plurality of layers in FIG. 2 include, among other layers, a first layer 90, a second layer 92, and a third layer 94 in a stacked configuration. As shown in the illustrated embodiment, the second layer 92 is positioned between the first layer 90 and the third layer 94. In some embodiments, the first layer 90 may interface with (e.g., is exposed to) the environment and the third layer 94 may interface with (e.g., is exposed to) the pouch interior 54 illustrated in FIG. 2. Additionally or alternatively, the first layer 90 may be disposed closer to the environment than the second layer 92 and the third layer 94, and the third layer 94 may be disposed closer to the pouch interior 54 than the first layer 90 and the second layer 92.

In some embodiments, the first layer 90 may be formed by a nylon material. Additionally, or alternatively, the first layer 90 may resist wear and/or scratches to the battery 50 over time. For example, the first layer 90 may reduce or eliminate corrosion to the second layer 92. The first layer 90 may also provide at least some structural stability for the battery pouch 52. Additionally, or alternatively, during manufacturing of the battery pouch 52, the first layer 90 may provide lubrication during a drying process.

The second layer 92 may include a structural layer of the battery pouch 52. For example, the second layer 92 may be formed by an aluminum material, a stainless-steel material, or the like. The second layer 92 may be bent, stretched, and/or shaped to create a shape and/or a size of the battery pouch 52. Additionally, or alternatively, the second layer 92 may provide the structural stability of the battery pouch 52.

The third layer 94 may include a sealant layer and/or an insulation layer of the battery pouch 52. For example, the third layer 94 may be formed by a polypropylene (PP) material. The third layer 94 may be positioned closer to the pouch interior 54 illustrated in FIG. 2 in comparison to the first layer 90 and the second layer 92, as previously described. The PP material of the third layer 94 may provide electrical insulation, which may reduce or eliminate shorting conditions, in certain embodiments. Additionally, or alternatively, the PP material of the third layer 94 may be chemically stable when interfacing with the electrolyte in the pouch interior 54 illustrated in FIG. 2.

In the illustrated embodiment , a first thickness 85 of the first layer 90 may be less than a second thickness 87 of the second layer 92 and/or a third thickness 89 of the third layer 94. By way of example, the first thickness 85 of the first layer 90 may be 10-20 microns in certain embodiments, the second thickness 87 of the second layer 92 may be 30-40 microns in certain embodiments, and/or the third thickness 89 of the third layer 94 may be 30-40 microns in certain embodiments. A total thickness 91 of the battery pouch 52, such as the first layer 90, the second layer 92, and/or the third layer 94, in addition to other possible layers described in detail below, may be 70-110 microns in certain embodiments. With respect to the first thickness 85 of the first layer 90 and the second thickness 87 of the second layer 92, for example, the layers may include a thickness ratio within a range of 1:4 (e.g., approximately 0.25) and 2:3 (e.g., approximately 0.667). Additionally, or alternatively, the first thickness 85 of the first layer 90 and the third thickness 89 of the third layer 94 may include a thickness ratio within a range of 1:4 (e.g., approximately 0.25) and 2:3 (e.g., approximately 0.667). Additionally, or alternatively, the second thickness 87 of the second layer 92 and the third thickness 89 of the third layer 94 may include a thickness ratio within a range of 3:4 (e.g., approximately 0.75) and 4:3 (e.g., approximately 1.33).

In certain instances, the battery pouch 52 may include a fourth layer 96 (or film) positioned between the first layer 90 and the second layer 92 and a fifth layer 98 (or film) adjacent to the first layer 90. The fourth layer 96 may include an adhesive layer that couples, binds, or adheres the first layer 90 to the second layer 92. That is, in some embodiments, the first layer 90 may be coated on (or adhered to) the second layer 92 via the adhesive of the fourth layer 96. The fifth layer 98 may include a matte layer that coats the first layer 90 to reduce or minimize porosity of the first layer 90 and/or for aesthetic purposes. In some embodiments, thicknesses of the fourth layer 96 (or film) and/or the fifth layer 98 (or film) may be less than or relatively small (e.g., 5 microns or less, or 3 microns or less) in comparison with the first thickness 85, the second thickness 87, and the third thickness 89 described above.

The battery pouch 52 may be formed by coating or adhering certain layers of the layered assembly with certain other layers of the layered assembly, such as the second layer 92 with one or more additional layers. For example, the battery pouch 52 may be formed by adhering the first layer 90 to a first surface of the second layer 92 (e.g., via the adhesive of the fourth layer 96), and by coating a second surface of the second layer 92 with the third layer 94, or vice versa. Other techniques for generating a layered assembly of the battery pouch 52 are also possible.

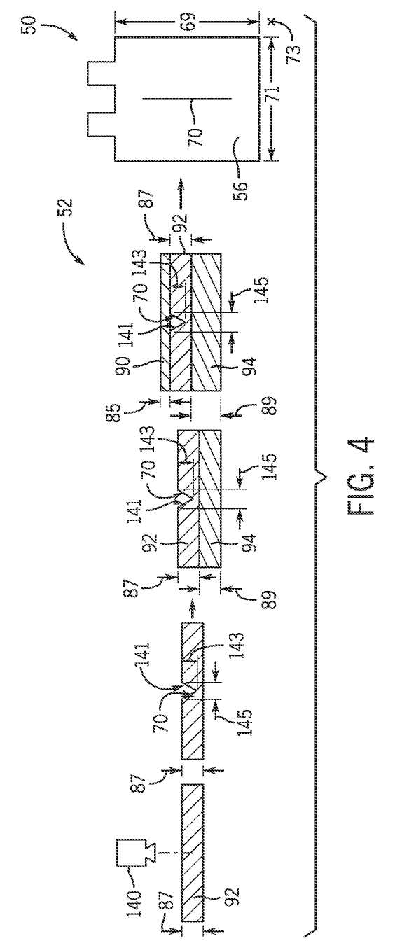

As discussed herein, the battery pouch 52 may include at least one notch formed in at least one layer of the plurality of layers. Although the notch is not illustrated in FIG. 3, it should be understood that the layered assembly of the battery pouch 52 in FIG. 3 may include a notch, which is illustrated in (and described with respect to below) later drawings. The notch may be formed prior to coating the second layer 92 with the one or more layers or after coating the second layer 92 in certain embodiments. That is, the notch may be formed after generating at least a portion of the layered assembly of the battery pouch 52 of FIG. 3 (e.g., after assembling at least two layers of the plurality of layers) in certain embodiments. With the foregoing in mind, FIGS. 4-12 schematically illustrate various instances of at least one notch, such as the notch 70 of FIG. 2, formed in at least one layer of the plurality of layers of the battery pouch 52.

FIG. 4 is a schematic diagram illustrating an embodiment of a process for forming a battery pouch, such as the battery pouch 52 of FIG. 2, having a plurality of layers, including laser etching the notch 70 into the second layer 92 of the battery pouch 52. The notch 70 may be referred to as a laser etching with respect to embodiments in which the notch 70 is formed via a laser etching technique. Prior to adhering the first layer 90 (e.g., nylon layer) and/or the third layer 94 (e.g., polypropylene layer) to the second layer 92 (e.g., aluminum layer), the notch 70 may be formed in the second layer 92 via a laser 140, as shown. That is, the laser 140 may remove a portion of the second layer 92 at a location to form the notch 70. For example, the portion of the second layer 92 that forms the notch 70 may be thinner (e.g., along the thickness 73 or depth direction of the battery 50) in comparison to the remaining portions of the second layer 92. Although the illustrated example includes the notch 70 formed in the second layer 92, it should be appreciated that the notch 70 may be formed in additional or other layer(s) of the plurality of layers in another embodiment.

The notch 70 may form a channel 141, as shown. For example, the channel 141 defined by the notch 70 may include a depth 143 of approximately 10-20 microns, although the depth 143 may vary in other embodiments to influence the threshold pressure at which venting occurs. As previously described, the second thickness 87 of the second layer 92 may be between 30-40 microns. In other words, the notch 70 may extend approximately 25% to 67% into the second thickness 87 of the second layer 92. Additionally, or alternatively, a width 145 (e.g., maximum width) of the notch 70 along the surface of the second layer 92 may be approximately 10-20 microns, although the width 145 may vary in other embodiments to influence the internal pressure at which venting occurs. While the notch 70 and corresponding channel 141 may include a triangular cross-sectional shape in the illustrated embodiment, the shape of the notch 70 and corresponding channel 141 may vary in other embodiments to influence the internal pressure at which venting occurs. For example, the notch 70 and the corresponding channel 141 may include a square cross-sectional shape in another embodiment.

After forming the notch 70, for example, on a first surface of the second layer 92, the first layer 90 (e.g., nylon layer) and/or the third layer 94 (e.g., polypropylene layer) may be adhered to the second layer 92 (e.g., aluminum layer), as previously described, noting that the fourth layer 96 illustrated in FIG. 3 may be employed to adhere the first layer 90 to the second layer 92 in certain embodiments. Stated differently, in certain embodiments, the first layer 90 may be disposed on (e.g., adhered to) the second layer 92 via the adhesive material of the fourth layer 96 illustrated in FIG. 3. Certain aspects of the present disclosure may refer to the first layer 90 being adhered or coupled to the second layer 92, which should be understood to mean that the first layer 90 may be directly adhered or coupled to (e.g., contacting) the second layer 92 or that the first layer 90 may be adhered or coupled to the second layer 92 via the adhesive of the fourth layer 96 illustrated in FIG. 3. In this way, the channel 141 may be disposed at the notch 70 and between the second layer 92 and the first layer 90, as shown. In other embodiments, the first layer 90 may be disposed on or adjacent to the first surface of the second layer 92 such that the first layer 90 fill at least a portion of the channel 141 (e.g., such that the first layer 90 extends into the channel 141 at least partially defined by the notch 70). The third layer 94 may be disposed on or adjacent to a second surface of the second layer 92 opposite the first surface, as previously described. Although not shown in the illustrated embodiments, adhesive or some other mechanism (e.g., heat) may be employed to coat the third layer 94 onto the second layer 92 (e.g., to adhere the third layer 94 to the second layer 92).

The battery pouch 52 may be formed using the plurality of layers. For example, the plurality of layers may be bent, stretched, and/or shaped into any suitable shape and/or size to form the battery pouch 52. During thermal testing of the battery 50, for example, the notch 70 may facilitate a break in the battery pouch 52 to release gases and/or pressure buildup within the pouch interior 54 illustrated in FIG. 2 to the environment, thereby meeting battery regulations and reducing and/or eliminating the chances of a thermal event. In the illustrated example, the threshold pressure at which the notch 70 causes the break through the battery pouch 52 may be dependent on a strength of the first layer 90 at or adjacent to the location of the notch 70 , a strength of the second layer 92 at or adjacent to the location of the notch 70 , a strength of the third layer 94 at or adjacent to the location of the notch 70 , strengths of other layers of the assembly at or adjacent to the location of the notch 70 , or any combination thereof. Strengths of the various layers of the battery pouch 52 may also be dependent on material constituents thereof. Additionally, or alternatively, the size of the notch 70 (e.g., the depth 143 and the width 145) and corresponding channel 141 and/or the shape of the notch 70 and corresponding channel 141 may influence the threshold pressure at which venting occurs. That is, the threshold pressure at which venting occurs may be adjustable by adjusting the shape and/or the size of the notch 70 and corresponding channel 141. Of course, as described in greater detail below with reference to later drawings, the layer(s) selected for having the notch 70 may also influence the threshold pressure at which venting occurs.

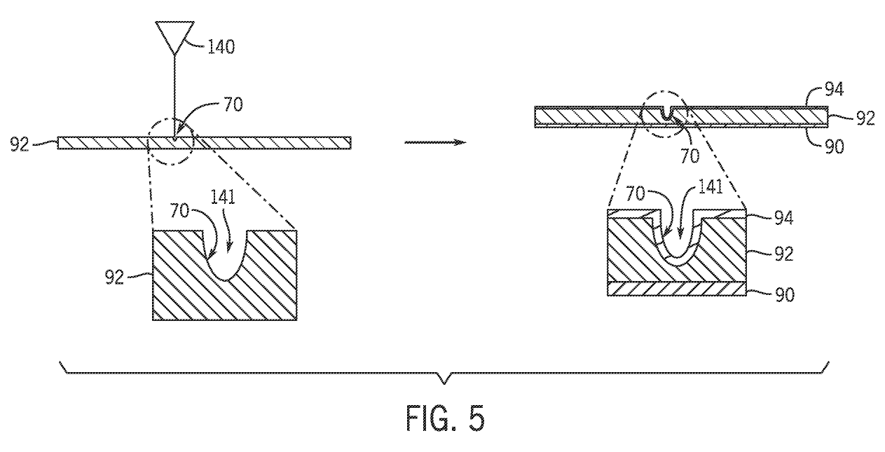

FIG. 5 is a schematic diagram illustrating an embodiment of a process for forming a battery pouch, such as the battery pouch 52 of the battery 50 illustrated in FIG. 2, having a plurality of layers, including laser etching the notch 70 in a surface of the second layer 92 (e.g., aluminum layer) of the plurality of layers and disposing the third layer 94 (e.g., polypropylene layer) of the plurality of layers onto the surface such that the third layer 94 extends into the channel 141 at least partially defined by the notch 70. As discussed herein, the laser 140 may form the notch 70 in the second layer 92, and the second layer 92 may be coated with the first layer 90 (e.g., nylon layer) and/or the third layer 94, noting that the first layer 90 may be coated onto (or adhered to) the second layer 92 via the adhesive of the fourth layer 96 illustrated in FIG. 3. As shown, the third layer 94 may fill at least a portion of the channel 141 defined by the notch 70. In other examples, the third layer 94 may coat the surface of the second layer 92 such that the channel 141 is defined or otherwise resides between the third layer 94 and the second layer 92 (e.g., the notch 70 of the second layer 82). Additionally, or alternatively, the present disclosure may refer to the notch 70 being formed in both the second layer 92 and the third layer 94 with respect to the illustrated embodiment. In FIG. 5, the third layer 94 (e.g., polypropylene layer) is shown as extending into (e.g., filling) at least a portion of the channel 141 defined at least in part by the notch 70. In another embodiment, the first layer 90 (e.g., nylon layer) may extend into (e.g., fill) at least a portion of the channel 141 defined at least in part by the notch 70. That is, in another embodiment, the notch 70 and the corresponding channel 141 may be disposed on an opposing surface of the second layer 92, and the first layer 90 may extend into the channel 141. Additionally, or alternatively, a shape of the notch 70 in FIG. 5 may differ from the embodiment illustrated in FIG. 4. For example, the shape of the notch 70 in FIG. 5 is curvilinear (e.g., the shape may be arcuate, a semi-circle, a semi-oval, etc.). However, a depth and/or width of the notch 70 in FIG. 5 may be similar to FIG. 4.

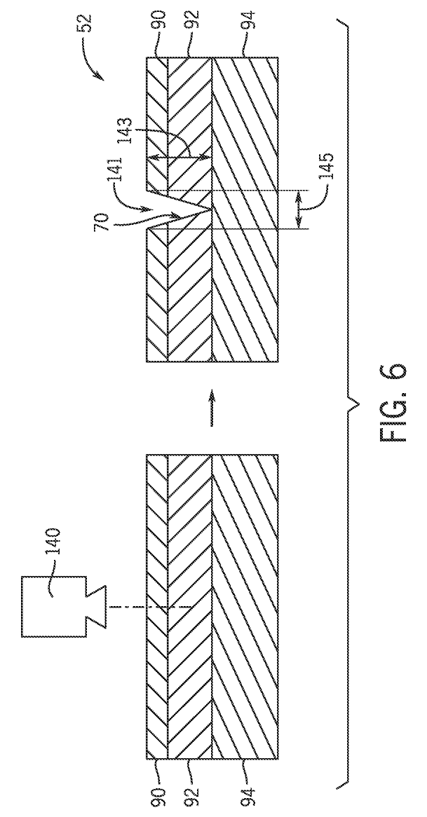

FIG. 6 is a schematic illustration of an embodiment of a process for forming a battery pouch, such as the battery pouch 52 of the battery 50 illustrated in FIG. 2, having a plurality of layers, including laser etching the notch 70 into at least two layers of the plurality of layers. In certain instances, the plurality of layers of the battery pouch 52 may be assembled (e.g., in a stacked configuration) prior to the laser etching by the laser 140. The laser 140 may form the notch 70 in both the first layer 90 and the second layer 92 by removing portions of both the first layer 90 and the second layer 92. For example, the laser 140 may remove a portion of the first layer 90 equivalent to the thickness of the first layer 90 and remove a portion of the second layer 92 less than the thickness of the second layer 92. Although not shown in FIG. 6, it should be understood that, in some embodiments, the fourth layer 96 illustrated in FIG. 3 may be disposed between the first layer 90 and the second layer 92, and the fifth layer 98 illustrated in FIG. 3 may be disposed atop the first layer 90, such that the notch 70 is formed through the first layer 90, the second layer 92, the fourth layer 96, and the fifth layer 98.

The depth 143 and/or the width 145 (e.g., maximum width) of the notch 70 and corresponding channel 141 in FIG. 6 may differ from the embodiment illustrated in FIG. 4. For example, the depth 143 in FIG. 6 may be larger than the depth 143 in FIG. 5. In one embodiment , the depth 143 may be approximately 40-50 microns (e.g., through the entirety of the first layer 90 and, in some embodiments, the fourth and fifth layers 96, 98 illustrated in FIG. 3, and through an entirety or a portion of the second layer 92 ). In some embodiments, the width 145 may be approximately 20-50 microns, although dimensions may vary based on the desired threshold pressure and/or other characteristics of the battery 50. While FIG. 6 illustrates the notch 70 in the first layer 90 (e.g., nylon layer) and the second layer 92 (e.g., aluminum layer), in another embodiment, the notch 70 may be disposed in the third layer 94 (e.g., polypropylene layer) and the second layer 92 (e.g., aluminum layer).

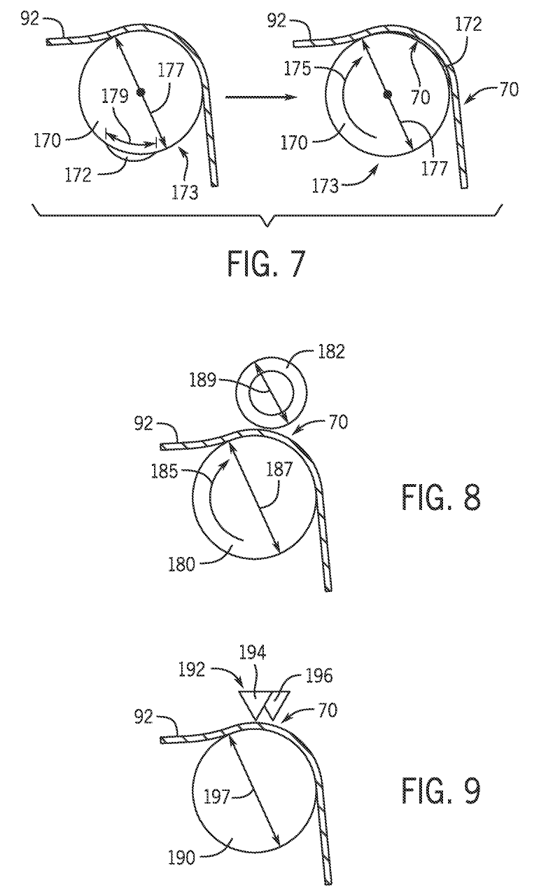

FIG. 7 is a schematic diagram illustrating an embodiment of a process for forming a notch, such as the notch 70 illustrated in FIG. 2, in at least one layer of a plurality of layers of the battery pouch 52 using a roller 170 and a blade 172 of the roller 170, collectively referred to as a bladed roller 173. The bladed roller 173 may be employed to dispose the notch 70 in the second layer 92 of the battery pouch 52. As shown, the second layer 92 may be positioned adjacent to the roller 170 and/or in contact with a circumference of the roller 170. As the roller 170 is moved (e.g., rotates) in a circumferential direction 175, for example, a position of the roller 170 and/or the second layer 92 may be adjusted such that the blade 172 of the roller 170 contacts the second layer 92 and disposes the notch 70 in the second layer 92 in certain embodiments. In this way, the notch 70 may be referred to as a bladed cut. In some embodiments, a diameter 177 of the roller 170 and/or a circumferential length 179 of the blade 172 on the roller 170 may be sized such that the notch 70 created in the second layer 92 includes a desired or target length.

Depending on the embodiment, either the roller 170, or the second layer 92, or both may be moved (e.g., in the circumferential direction 175) to cause the blade 172 of the roller 170 to contact the second layer 92 and dispose the notch 70 in the second layer 92. In one embodiment, the second layer 92 may be maintained or fixed in a position as the roller 170 is rotated in the circumferential direction 175, as described above. In another embodiment, the roller 170 may be maintained or fixed in a position as the second layer 92 is moved or pulled along a circumference of the roller 170 to cause the second layer 92 to come into contact with the blade 172 of the roller 170, thereby disposing the notch 70 into the second layer 92. Movement of the roller 170, the second layer 92, or both may be controlled based on a desired or target length of the notch 70 in the second layer 92, as previously described.

FIG. 8 is a schematic diagram of an embodiment of a roller 180 and a blade 182 separate from the roller 180, where the blade 182 and the roller 180 are configured to coordinate to dispose a notch in at least one layer of a battery pouch, such as the second layer 92. In the illustrated example, the roller 180 and the blade 182 may be individual components positioned proximate to each other, where the second layer 92 may be positioned between the roller 180 and the blade 182. In certain embodiments, as the roller 180 rotates in a circumferential direction 185, a position of the second layer 92 may be adjusted as the blade 182 contacts the second layer 92 to form the notch 70 in the second layer 92. Additionally, or alternatively, in certain embodiments, the blade 182 may be lowered onto the second layer 92 and/or moved about the second layer 92 to dispose the notch 70 in the second layer 92. A diameter 187 of the roller 180, a diameter 189 of the blade 182, or both may be sized to create the notch 70 such that the notch 70 includes a desired or target length. Additionally, or alternatively, movement of the roller 180 and/or the blade 182 may be controlled to create the notch 70 such that the notch 70 includes the desired or target length.

FIG. 9 is a schematic illustration of forming an embodiment of a roller 190 and a blade assembly 192 separate from the roller 190, where the blade assembly 192 includes a first blade 194 and a second blade 196, and the roller 190 and the blade assembly 192 are configured to coordinate to dispose multiple notches in at least one layer of a plurality of layers of a battery pouch, such as the second layer 92. The blades 194, 196 may be positioned along a central axis of the roller 190 and scratch (e.g., etch) the second layer 92 to form the notches 70. For example, the blades 194. 196 may contact a surface (e.g., the first surface) of the second layer 92 to form the notches 70. A length of the notches 70 may be determined based on a contact time between the blades 194, 196 and the second layer 92. A depth of the notch 70 in the depth direction may be determined based on a length of the blades 194, 196 and/or a proximity of the blades 194, 196 with the roller 190. For example, a position of the blades 194, 196 may be adjusted in the depth direction to selectively contact with the second layer 92. Further, a diameter 197 of the roller 190 may influence characteristics of the notches 70, such as lengths thereof.

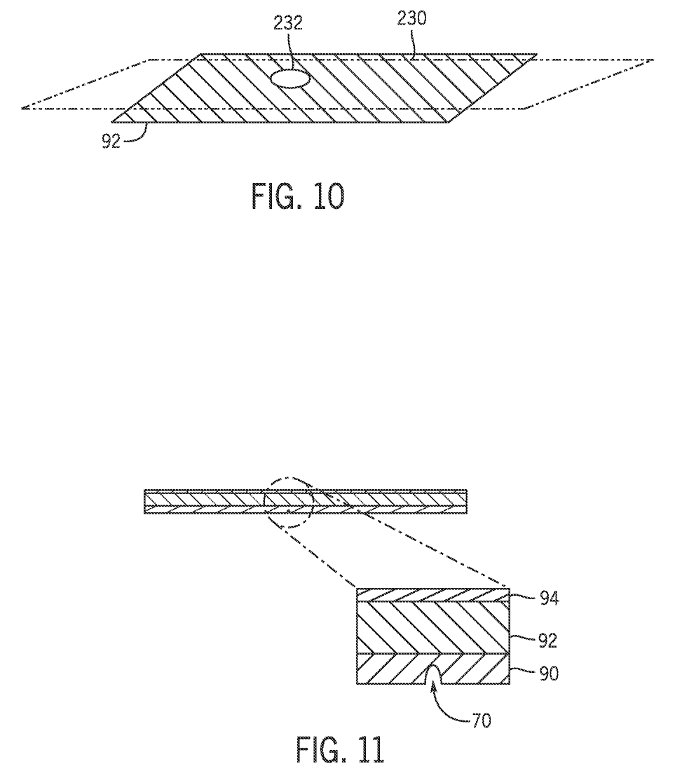

FIG. 10 is a schematic perspective view of a chemical mask 230 employed in a chemical etching process to dispose a notch, such as the notch 70 illustrated in FIG. 2, in at least one layer of a plurality of layers of a battery pouch, such as the battery pouch 52 of the battery 50 illustrated in FIG. 2. The chemicals may interact with the second layer 92 and remove a portion of material from the second layer 92 to form the notch 70 via the chemical etching. In this way, the notch 70 of FIG. 10 may be referred to as a chemical etching. To expose only the portion of the second layer 92 to the chemicals, the mask 230 may cover a surface of the second layer 92 during the chemical etching, where a first portion of the surface of the second layer 92 may be covered to by the mask 230 and not exposed to chemicals and a second portion of the surface of the second layer 92 may be exposed to the chemicals. The mask 230 may include tape, film, paint, and so on that may temporarily adhere to a surface of the second layer 92. In certain instances, both surfaces of the second layer 92 may be covered by respective masks 230. The mask(s) 230 may include a hole 232 (e.g., a removed portion) that exposes the portion of the second layer 92. For example, the hole 232 may be formed by removing a portion of the mask 230.

The second layer 92 and the mask 230 may be exposed to one or more chemicals to perform the chemical etching. For example, the second layer 92 and the mask 230 may be dipped into the chemicals to form the notch 70 for a period of time. A shape and/or a size of the notch 70 may be similar to a shape and/or a size of the hole 232 exposing the portion of the second layer 92. Additionally, or alternatively, a shape and/or a size of the notch 70 may be based on a contact time between the second layer 92 and the chemicals, a strength of the chemicals, a type of chemical, and so on. In another example, the chemicals may be brushed onto the portion of the surface of the second layer 92 to form the notch 70. The second layer 92 and/or the mask 230 may be cleaned after the chemical etching to remove the chemicals from the second layer 92. The mask 230 may then be removed from the second layer 92. As such, the notch 70 may be formed in the second layer 92 using chemical etching.

FIG. 11 is a schematic cross-sectional view of a battery pouch, such as the battery pouch 52 of the battery 50 of FIG. 2, having the notch 70 formed in at least one layer of the plurality of layers of the battery pouch 52. The notch 70 may be formed in the first layer 90 (e.g., nylon layer) by mechanical etching, laser etching, chemical etching, a bladed cut, and the like in the illustrated embodiment, for example, such that a depth of the notch 70 is 5-10 microns. As previously described, the first layer 90 (e.g., nylon layer) may be disposed closer to the environment than the second layer 92 and the third layer 94, although in some embodiments, the fifth layer 98 (e.g., matte layer) illustrated in FIG. 3 may be disposed between the environment and the first layer 90.

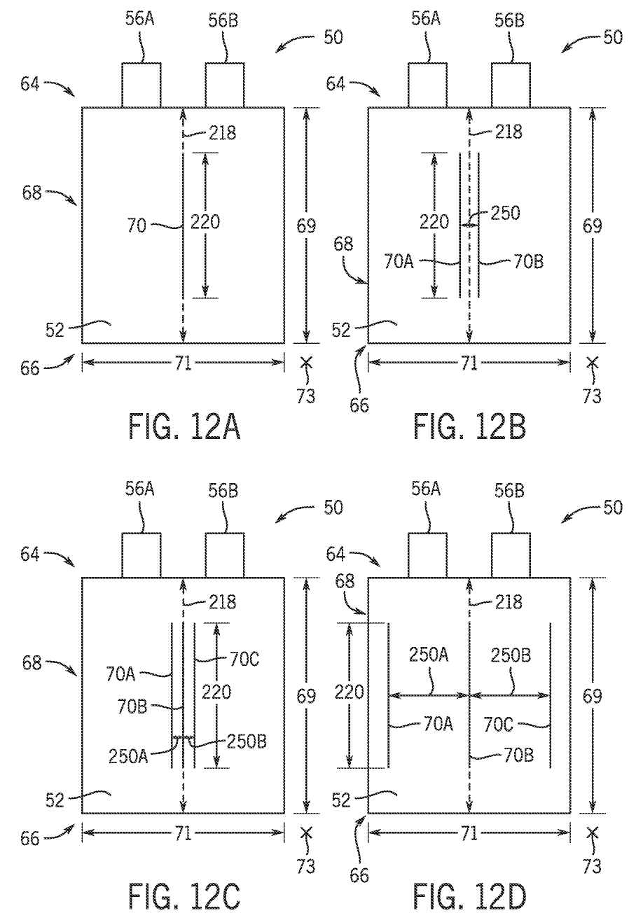

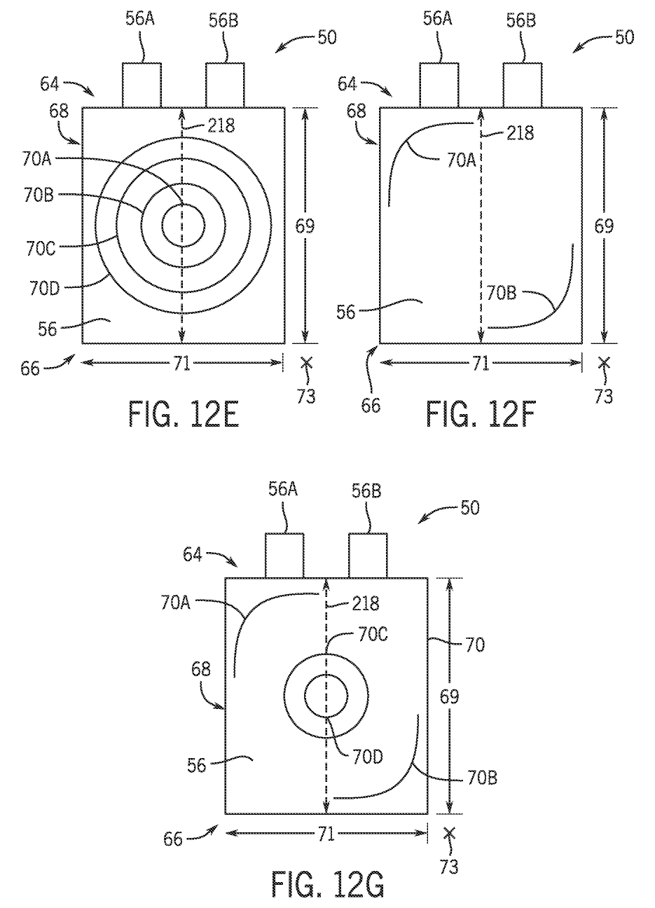

FIGS. 12A-G are schematic illustrations of a battery pouch, such as the battery pouch 52 of FIG. 2, where the battery pouch 52 includes at least one notch 70 along the body 68 of the battery pouch 52. As previously described, and as shown in each of FIGS. 12A-G, the battery pouch 52 may include the first side 64 through which at least one terminal 56 (e.g., the first terminal 56A and the second terminal 56B) extends, the second side 66 opposite the first side 64, and the body 68 extending from the first side 64 to the second side 66, where the at least one notch 70 is formed along the body 68 of the battery pouch 52. That is, the body 68 of the battery pouch 52 may extend from the top of the battery pouch 52 (e.g., the first side 64) to a bottom of the battery pouch 52 (e.g., the second side 66). The battery pouch 52 may include the height 69 extending from the first side 64 to the second side 66, the width 71 extending transverse to the height 69, and the thickness 73 (or depth) extending transverse to the height 69 and the width 71 from a front to a back of the battery pouch 52, as shown. As described in detail below, the battery pouch 52 may include any suitable number of notches 70 in any suitable shape and/or size (e.g., height, width, depth). As previously described, characteristics of the at least one notch 70 (e.g., size, shape, etc.) may depend on various characteristics of the battery 50, such as a size of the battery 50, a shape of the battery 50, a type of the battery 50, material constituents of the battery 50 (e.g., of the electrodes, of the plurality of layers of the battery pouch 52, etc.), a target threshold pressure at which venting occurs, etc. For example, the design of the battery pouch 52 including the at least one notch 70 may be tunable based on a target threshold pressure. Additionally, or alternatively, the at least one notch 70 (e.g., multiple notches) may be patterned on both sides of the battery pouch 52, such as both sides of the body 68 of the battery pouch 52.

FIG. 12A is a schematic front view of a battery pouch, such as the battery pouch 52 of the battery 50 of FIG. 2, where the battery pouch 52 includes the notch 70 along the body 68 of the battery pouch 52. As illustrated, the notch 70 may be positioned along or relatively close to a central axis 218 (e.g., longitudinal axis) of the battery pouch 52, such as inwards from locations of the terminals 56A, 56B, and extend in a substantially straight line along the height 69 of the battery pouch 52. A length 220 of the notch 70 may be, for example, 50% to 75% of the height 69 of the battery pouch 52 based on a desired or target threshold pressure at which venting occurs, although the length 220 may vary in other embodiments.

FIG. 12B is a schematic front view of a battery pouch, such as the battery pouch 52 of the battery 50 of FIG. 2, where the battery pouch 52 includes a first notch 70A and a second notch 70B (collectively referred to as “notches 70”). As illustrated, the notches 70 extend in a substantially straight line along the height 69 of the battery pouch 52 (e.g., on opposing sides of the central axis 218). As illustrated, the first notch 70A and the second notch 70B may be the same length 220, each of which may be 50% to 75% of the height 69 of the battery pouch 52, although the length 220 may vary in other embodiments. Further, in some embodiments, the first notch 70A and the second notch 70B include different lengths. The first notch 70A and the second notch 70B may be separated by a distance 250 extending along the width 71 of the battery pouch 52. The distance 250 may may be any suitable distance. For example, the distance 250 may be approximately 5% to 25% of the width 71 of the battery pouch 52 based on a desired or target threshold pressure at which venting occurs, although the distance 250 may be different in other embodiments.

FIG. 12C is a schematic front view of a battery pouch, such as the battery pouch 52 of the battery 50 of FIG. 2, where the battery pouch 52 includes a first notch 70A, a second notch 70B, and a third notch 70C (collectively referred to as “notches 70”). As illustrated, the notches 70 extend along the height 69 of the battery pouch 52 and the notches 70 are the same length 220 (e.g., 50% to 75% of the height 69 of the battery pouch 52). In other embodiments, the notches 70 may extend along (e.g., parallel to) the width 71 of the battery pouch 52 and/or the notches 70 may be different lengths.

The first notch 70A and the second notch 70B may be separated by a first distance 250A. The second notch 70B and the third notch 70C may be separated by a second distance 250B. The distances 250A, 250B may extend along the width 71 of the battery pouch 52. As illustrated, the first distance 250A and the second distance 250B may be the same (e.g., substantially equal to one another). The first distance 250A may be approximately 2% to 15% of the width 71 of the battery pouch 52, and the second distance 250B may be approximately 2% to 15% of the width 71 of the battery pouch 52 in certain embodiments. Additionally, or alternatively, the first distance 250A and the second distance 250B may be different in certain embodiments. As shown, the second notch 70B may extend along the central axis 218 of the battery pouch 52, while the first notch 70A and the third notch 70C may be disposed on opposing sides of the central axis 218. In certain instances, a greater number of notches 70 may result in a lower threshold pressure in comparison to a smaller number of notches 70.

With the foregoing in mind, FIG. 12D is a schematic front view of a battery pouch, such as the battery pouch 52 of the battery 50 of FIG. 2, where the battery pouch 52 includes a first notch 70A, a second notch 70B, and a third notch 70C. The battery pouch 52 of FIG. 12D is substantially similar to the battery pouch 52 of FIG. 12C, except that the distances 250A, 250B of the battery pouch 52 of FIG. 12D are greater than the distances 250A, 250B of the battery pouch 52 of FIG. 12C. For example, the first distance 250A in FIG. 12D may be approximately 15% to 40% of the width 71 of the battery pouch 52, and the second distance 250B in FIG. 12D may be approximately 15% to 40% of the width 71 of the battery pouch 52. In certain instances, a shorter distance between the notches 70 may result in lower threshold pressure in comparison to a greater distance between the notches 70. Since the distances 250A, 250B of the battery pouch 52 of FIG. 12D are greater than the distances 250 of the battery pouch 52 of FIG. 12C, the overall threshold pressure of the battery pouch 52 of FIG. 12D may be greater than the overall threshold pressure of the battery pouch 52 of FIG. 12C. Accordingly, the embodiment illustrated in FIG. 12C may be suitable for certain battery types and the embodiment illustrated in FIG. 12D may be suitable for certain other battery types based on differing desired or target threshold pressures.

FIG. 12E is a schematic front view of a battery pouch, such as the battery pouch 52 of the battery 50 of FIG. 2, where the battery pouch 52 includes a first notch 70A, a second notch 70B, a third notch 70C, and a fourth notch 70D (collectively referred to herein as “notches 70”). As illustrated, a first shape of the first notch 70A may be a first circle, a second shape of the second notch 70B may be a second circle, a third shape of the third notch 70C may be a third circle, and a fourth shape of the fourth notch 70D may be a fourth circle. It should be understood that the notches 70 may be any suitable shape, such as square, triangle, hexagon, oval, and so on.

The notches 70 may be any suitable size. For example, the first notch 70A may be smaller than the second notch 70B. As illustrated, the second notch 70B may encircle the first notch 70A. Additionally, the third notch 70C may be bigger than the second notch 70B, and the fourth notch 70D may be bigger than the third notch 70C. As illustrated, the fourth notch 70D may encircle the third notch 70C, and the third notch 70C may encircle both the second notch 70B and the first notch 70A.

The notches 70 may be positioned at any suitable location along the body 68 of the battery pouch 52. As illustrated, the notches 70 may be positioned along (e.g., centered on) a central axis 218 of the battery pouch 52. In other instances, the notches 70 may align with a central axis of the first terminal 56A, a central axis of the second terminal 56B, along an edge of the body 68 of the battery pouch 52, and so on.

FIG. 12F is a schematic front view of a battery pouch, such as the battery pouch 52 of FIG. 2, where the battery pouch 52 includes a first notch 70A and a second notch 70B. As illustrated, a shape of the first notch 70A and the second notch 70B may include curved lines (e.g., non-linear, non-straight). The first notch 70A may be positioned proximate to the first side 64 and the first terminal 56A. The second notch 70B may be positioned proximate to the second side 66 and opposite from the first notch 70A.

The first notch 70A and the second notch 70B may be any suitable shape and/or size. As illustrated, a length of the first notch 70A and the second notch 70B may be the same. Additionally, or alternatively, a depth of the first notch 70A and the second notch 70B may be the same. As such, the threshold pressure of the first notch 70A and the second notch 70B may be the same or substantially similar. During thermal testing of the battery 50, for example, the first notch 70A and the second notch 70B may facilitate at least one break in the battery pouch 52 based on a pressure being applied in the pouch interior 54 exceeding a threshold pressure of the first notch 70A and the second notch 70B, respectively.

FIG. 12G is a schematic front view of a battery pouch, such as the battery pouch of FIG. 2, where the battery pouch 52 includes a first notch 70A, a second notch 70B, a third notch 70C, and a fourth notch 70D. The first notch 70A and the second notch 70B may be similar to the first notch 70A and the second notch 70B discussed with respect to FIG. 12F. The third notch 70C and the fourth notch 70D may be similar to the first notch 70A and the second notch 70B discussed with respect to FIG. 12E. The design of the battery pouch 52 may be tunable (e.g., adjustable) by adjusting a shape, a size, and/or a number of notches 70 patterned onto the battery pouch 52, as previously described. Furthermore, the notches 70 may be patterned into at least one layer of the plurality of layers of the battery pouch 52, which may further increase flexibility of the design.

Various embodiments of the battery 50 and the battery pouch 52, including the plurality of layers of the battery pouch 52 and the at least one notch 70 disposed in at least one layer of the plurality of layers, are illustrated in FIGS. 2-12 and described in detail above. It should be understood that these embodiments may be susceptible to various modifications and alternative forms, including combination(s) of features across these embodiments. As one such example, an embodiment in accordance with the present disclosure may include the notch 70 formed in the second layer 92 as illustrated in FIGS. 4 and 5, along with the notch 70 formed in the first layer 90 as illustrated in FIG. 11. Other combinations of features across various embodiments of the present disclosure are also possible.

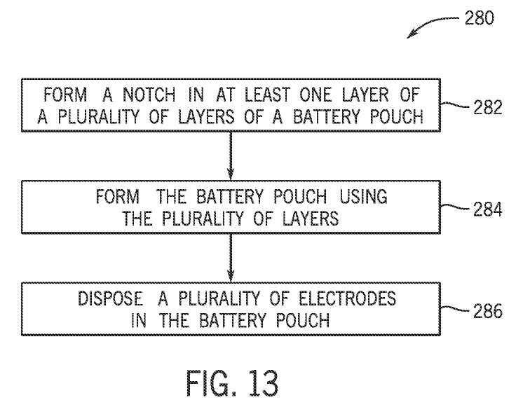

FIG. 13 is a process flow diagram illustrating a method 280 of manufacturing a battery in any of FIGS. 2-12 described above. It should be appreciated that the method 280 may be performed in any viable order. Moreover, it should be appreciated that in different embodiments, the method 280 may include additional and/or reduced process blocks.

The method 280 includes forming (block 282) a notch in at least one layer of a plurality of layers of a battery pouch of the battery. As discussed with respect to FIGS. 4-6, the notch may be formed in a first layer (e.g., a nylon layer), a second layer (e.g., an aluminum layer), and/or a third layer (e.g., a polypropylene layer), where the second layer is between the first layer and the third layer. In certain embodiments, the notch may be formed in a fourth layer (e.g., an adhesive layer) between the first layer and the second layer, a fifth layer (e.g., a matte layer) disposed atop the first layer, or both. As previously discussed, the notch may be formed via a laser etching, a bladed cut, a mechanical etching, a chemical etching, or the like.

The method also includes forming (block 284) the battery pouch using the plurality of layers, where at least one layer of the plurality of layers includes the notch as discussed above. For example, the plurality of layers may be bent, stretched, and/or shaped to form the battery pouch.

The method also includes disposing (block 286) a plurality of electrodes in the battery pouch. The battery pouch may define a pouch interior configured to receive a plurality of electrodes of the battery. The pouch interior may also receive the electrolyte of the battery. The battery pouch may be sealed to form the battery, as previously described.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…,” it is intended that such elements are to be interpreted under 35 U.S.C. 112(f). However , for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A battery comprising:
a plurality of electrodes; and
a pouch defining a pouch interior configured to enclose the plurality of electrodes, wherein the pouch comprises:
a plurality of layers comprising a nylon layer, a polypropylene layer, and an aluminum layer between the nylon layer and the polypropylene layer, wherein the polypropylene layer is closer to the pouch interior than the nylon layer and the aluminum layer; and
a notch formed in at least one layer of the plurality of layers, wherein the notch is configured to facilitate a break in the pouch through the plurality of layers at or adjacent to the notch based on a pressure being applied in the pouch interior exceeding a threshold pressure.

2. The battery of claim 1, wherein the plurality of layers comprises a matte layer adjacent to the nylon layer such that the nylon layer is between the matte layer and the aluminum layer.

3. The battery of claim 1, wherein the plurality of layers comprises an adhesive layer between the aluminum layer and the nylon layer.

4. The battery of claim 1, wherein the at least one layer comprises the nylon layer.

5. The battery of claim 1, wherein the at least one layer comprises the aluminum layer.

6. The battery of claim 1, wherein the at least one layer comprises the polypropylene layer.

7. The battery of claim 1, wherein the at least one layer comprises the nylon layer and the aluminum layer.

8. The battery of claim 1, wherein the at least one layer comprises the polypropylene layer and the aluminum layer.

9. The battery of claim 1, wherein the notch comprises a mechanical etching, a chemical etching, a laser etching, or a bladed cut.

10. The battery of claim 1, wherein a first thickness of the nylon layer is less than a second thickness of the aluminum layer and less than a third thickness of the polypropylene layer.

11. The battery of claim 1, comprising at least one terminal, wherein the pouch comprises:
a first side through which the at least one terminal extends;
a second side opposing the first side; and
a body extending from the first side to the second side, wherein the notch is formed in the at least one layer of the plurality of layers along the body of the pouch.

12. The battery of claim 11, wherein the body of the pouch comprises a height extending from the first side to the second side and a width extending transverse to the height, and the notch forms a line extending along the width.

13. The battery of claim 11, wherein the body of the pouch comprises a height extending from the first side to the second side and a width extending transverse to the height, and the notch extends in a substantially straight line along the height.

14. The battery of claim 13, comprising a plurality of additional notches extending in a substantially straight line along the height, wherein the notch and each additional notch of the plurality of additional notches are separated by a distance along the width.

15. A method, comprising:
forming a notch in an aluminum layer;
adhering a nylon layer to a first surface of the aluminum layer;
adhering a polypropylene layer to a second surface of the aluminum layer opposing the first surface of the aluminum layer;
forming a battery pouch using the aluminum layer, the nylon layer, and the polypropylene layer; and
forming a battery by disposing one or more electrodes into the battery pouch.

16. The method of claim 15, comprising adhering the nylon layer to the first surface of the aluminum layer such that a channel defined by the notch disposed in the first surface of the aluminum layer is positioned between the nylon layer and the aluminum layer.

17. The method of claim 16, comprising adhering the polypropylene layer to the second surface of the aluminum layer such that the polypropylene layer extends into a channel defined by the notch disposed in the second surface of the aluminum layer.

18. A battery comprising:
a plurality of electrodes; and
a pouch defining a pouch interior configured to enclose the plurality of electrodes, wherein the pouch comprises:
an aluminum layer;
at least one notch formed in a surface of the aluminum layer; and
a nylon layer adhered to the surface of the aluminum layer such that the nylon layer extends into or over a channel at least partially defined by the at least one notch.

19. The battery of claim 18, comprising at least one terminal, wherein the pouch comprises:
a first side through which the at least one terminal extends;
a second side opposing the first side; and
a body extending from the first side to the second side, wherein the at least one notch is positioned along the body of the pouch, the at least one notch comprises a first notch and a second notch, a first shape of the first notch is a first circle, and a second shape of the second notch is a second circle.

20. The battery of claim 18, comprising a polypropylene layer, wherein the polypropylene layer is closer to the pouch interior than the nylon layer and the aluminum layer, and the aluminum layer is positioned between the nylon layer and the polypropylene layer.
